(19) United States
(12) Patent Application Publication
(10) Pub. No.: US 2013/0133419 A1
(43) Pub. Date: May 30, 2013

(54) MAGNETIC LEVITATION FOR FORENSICS ANALYSIS

(71) Applicants: George M. Whitesides, Newton, MA (US); Matthew R. Lockett, Cambridge, MA (US); Katherine A. Mirica, Waltham, MA (US); Charles R. Mace, Auburn, NY (US); Robert D. Blackledge, El Cajon, CA (US)

(72) Inventors: George M. Whitesides, Newton, MA (US); Matthew R. Lockett, Cambridge, MA (US); Katherine A. Mirica, Waltham, MA (US); Charles R. Mace, Auburn, NY (US); Robert D. Blackledge, El Cajon, CA (US)

(21) Appl. No.: 13/594,518

(22) Filed: Aug. 24, 2012

Related U.S. Application Data
(60) Provisional application No. 61/527,322, filed on Aug. 25, 2011.

(51) Int. Cl. G01N 9/00

(52) U.S. Cl. CPC G01N 9/00
USPC 73/32 R

(57) ABSTRACT

A method for determining the density of contact trace objects with magnetic levitation is described. The density of samples of glitter and of gunpowder was determined, and the feasibility of magnetic levitation as a possible means of characterizing forensic-related evidence is discussed. The magnetic levitation device (composed of two permanent magnets with like poles facing) and the method described provides a means of accurately determining the density of trace objects that is inexpensive, rapid, verifiable, provides documentation, is independent of the specific apparatus or analyst, and provides numerical values (rather than a comparison between questioned and known samples) that may be entered into a searchable database.

### CROSS REFERENCE TO RELATED APPLICATIONS

The present application claims the benefit of the earlier filing date of U.S. Patent Application No. 61/527,322, filed on Aug. 25, 2011, the contents of which are incorporated by reference herein in its entirety.

### INCORPORATION BY REFERENCE

All patents, patent applications and publications cited herein are hereby incorporated by reference in their entirety in order to more fully describe the state of the art as known to those skilled therein as of the date of the invention described herein.

### TECHNICAL FIELD

this technology relates generally to the analysis of trace evidence. In particular, this invention relates to a density analysis of trace objects.

### BACKGROUND

Trace evidence is evidence that occurs when different objects contact one another. Such materials are often transferred by contact friction. Common contact trace objects are used in forensic investigations to establish an association or connection between events and people (e.g., link criminals to crime scenes and to victims). Most of these objects are diamagnetic in nature and interact weakly with a magnetic field. Common trace objects include hairs, fibers, paint chips, and fragments of broken glass. Glitter is another—less often exploited—contact trace material that has been used as associative evidence. Contact trace objects are characterized with tests that range in difficulty and expense, from visual or microscopic inspection to spectroscopic analysis.

The density of an object is another physical parameter that could, in principle, be used to characterize a trace object. Conventional density measurements of an irregularly-shaped object employ a displacement measurement to determine its volume. Volume measurements are difficult for small objects such as glitter particles and other contact trace objects.

Another method, often called the “sink/float method,” has been used to analyze glass fragments. The method uses density columns that are prepared by mixing two organic liquids (e.g., bromoform and bromobenzene) in a specific ratio. Questioned and known glass fragments are placed together in the mixture, and the ratio of the organic liquids is adjusted until the two glass fragments could be distinguished (i.e., one fragment floated to the top of the density column while the other sank to the bottom). If the two glass fragments could be separated then the glass samples could not have originated from the same source. If the two glass fragments could not be separated (i.e., floated or sank together) and could also be suspended within the density column at a specific liquid ratio, then one could conclude both fragments could have originated from the same source, and that their density corresponded to the density of the liquid mixture.

There exists a need for a method that makes it possible to determine the density of trace objects quickly and easily.

### SUMMARY

The analysis of trace contact objects and other unknowns using magnetic levitation is described.

In one aspect, a method of classifying the origin of a trace object found at a location or on a person is provided. The method includes preparing a suspension of an unknown trace object in a paramagnetic solution, wherein the unknown trace object is obtained from a person or at a location of interest; applying a magnetic field to the suspension containing the trace object, wherein the position of the trace object in the magnetic field is an indication of its density; and comparing the density of the trace object with densities of one or more objects of known origin, wherein a density match provides an indication of a common origin between the trace object and the objects of known origin.

In one or more embodiments, origin is selected from the group consisting of a manufacturing origin, a geographic location, ownership and combinations thereof.

In one or more embodiments, the density is determined utilizing a database containing position information correlated with a predetermined density.

In one or more embodiments, origin of the trace object is determined by comparison to a database containing origin of known objects and density.

In one or more embodiments, the trace object is selected from the group consisting of hair, fiber, bone, wood, ivory, smokeless gunpowder, fibers, hair, glitter, shimmer, glass, dried tree sap, leafy material, feathers, sequins, small jewelry items, buttons, various types of color-effect pigments used in cosmetic products, soil and sand, dried glues, false eyelashes, acrylic fingernails, cremains, cooled hardened metal globules and glass beads produced from industrial processes such as welding or in blast furnaces or electrical power plants, automotive rubber and plastic trim pieces, metal fragments and shavings from industrial sources, dried paint chips, latex condom lubricants, as well as any relatively non-volatile liquids.

In one or more embodiments, density is determined at the point of collection, and for example, the location of collection is a crime scene.

In one or more embodiments, the trace objects are not washed or rinsed prior to testing, or the trace objects are cleaned of debris prior to testing.

In one or more embodiments, the paramagnetic solution comprises a surfactant.

In one or more embodiments, the suspension is degassed prior to or during application of the magnetic field and/or the suspension is sonicated prior to application of the magnetic field.

In one or more embodiments, the trace object is glitter and the glitter is separated from a carrier prior to testing.

In some aspects, the method further includes receiving information about a second property of the trace object and comparing the information about the second property to properties of objects of known origin, wherein a property match is a further indication of a common origin.

In one or more embodiments, the trace object is glitter and the second property is selected from the group consisting of color, size, morphology, thickness, shape, and layers.

In one or more embodiments, the trace object is gun powder and the second powder is selected from the group consisting of color, size, shape and morphology.

In other aspects, a system for identifying the origin of a trace obj found at a location or on a person is provided. The system includes a pair of permanent magnets positioned to provide a magnetic field of a predetermined field gradient; a sample holder located within the magnetic field for receiving a sample comprising a trace object; and a memory for storing a data base containing the origin of known objects correlated with a determined density; and computer readable medium containing instructions for comparing a measured density against the determined densities of the data base and identifying a match.

These and other aspects and embodiments of the disclosure are illustrated and described below.

### BRIEF DESCRIPTION OF THE DRAWINGS

The invention is described with reference to the following figures, which are presented for the purpose of illustration only and are not intended to be limiting.

FIG. 1 is a schematic illustration of a magnetic levitation device according to one or more embodiments.

FIG. 2 is a series of time lapsed photographs of a sample of glitter (Mirror Crystalina I) placed in cuvette containing an aqueous solution of 3.0 M MnCl₂, shaken to disperse the glitter throughout the solution, and placed in the magnetic levitation device.

FIG. 3 illustrates samples of glitter (Crystalina #321) containing 2, 20, or 100 pieces of glitter levitated in a cuvette containing 3.0 M MnCl₂ and two density standards (1.350 and 1.450 g/cm³; light and dark color, respectively).

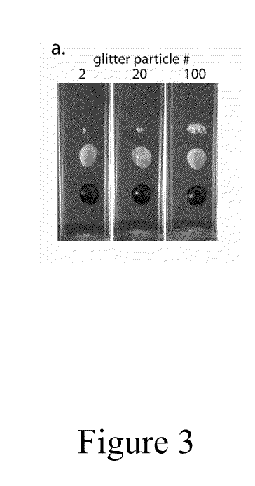

FIG. 4 is a sample of gunpowder (Hercules Blue Dot) levitated in a cuvette containing a 4.0M MnCl₂ solution and two density standards (1.450 and 1.800 g/cm³; dark and light color, respectively), placed in the magnetic levitation device and photographed after 360 seconds.

FIG. 5 is an optical microscope image of a mixture of Mirror Crystalina I and Chrome Silver 1P glitter samples; and (b) a photograph illustrating the separation of the two glitter samples by magnetic levitation.

### DETAILED DESCRIPTION

Magnetic levitation (“MagLev”) is a convenient and low-cost means for accurately determining the density (with a resolution of 0.02-0.0002 g/cm³) of a diamagnetic object. The technique involves placing diamagnetic samples into a container filled with a paramagnetic fluid, which is then placed between two permanent magnets. The vertical position of the sample, in the presence of the magnetic field, correlates with its density. This position of the sample is independent of mass or volume, and measurements of density by magnetic levitation thus do not require standardized sample sizes. Further detail can be found in US Appln. Publ. No. 2010/0285606-A1, which is incorporated in its entirety by reference.

Magnetic levitation of diamagnetic objects is well-suited for analyzing contact trace objects: i) it does not destroy the sample, ii) it is readily calibrated with a series of density standards, and iii) it is applicable to small and irregularly shaped particles. Magnetic levitation is a versatile technique whose sensitivity can be adjusted to the application.

Forensic investigations use the analysis of trace objects to assist in the investigation of a crime in a variety of ways. As used herein, “trace object” means a small, lightweight object, whose location at a particular site provides evidence of an association with a crime, an event or act under investigation or a crime scene.

Contact trace objects found at a crime scene (or related locations), on the victim or the alleged perpetrator can be used to establish a relationship or association between events and individuals. Absent any unusual surface properties, these small and lightweight particles are more likely to transfer and stick, making them excellent association evidence. For example, the larger gunshot residue particles have poor retention on the hands of a shooter, but the small particles are likely to remain. Similarly, glitter originating from cosmetic products was found to readily transfer and be retained.

Forensic science is often called upon to determine a ‘match’ between trace objects, for example, between a sample found on the victim with that found on the accused perpetrator. In other instances, forensic science seeks to determine whether trace evidence can be matched with a particular source, e.g., a manufacturer or a geographic location.

Most trace objects are class type evidence, that is, the object does not possess wholly unique attributes, but rather shares such attributes with members of its class. With class evidence the smaller the class into which it can be placed, the greater its value as associative evidence. The more ways in which trace objects from different sources can be shown to vary, the smaller the subclass into which an individual particle may be placed. The smaller the subclass, the more it has value as associative evidence. Density provides an additional method of characterizing trace objects, so as to further narrow its class.

In one aspect, the density of a trace object (the unknown) is determined by preparing a suspension of the trace object in a paramagnetic solution. The trace object may be obtained from a person, object or location of interest due to a possible crime or in the course of an investigation. The suspended trace object is subjected to a magnetic field, so that the object(s) levitate at a height that is characteristic of its density.

In some instances, the absolute density of the trace object can be determined by reference to standard density curves (generated, for example, by measuring the levitation height of density standards in the same solution and magnetic field strength). The measured density can be compared to the density of objects to determine whether the density of the unknown trace object matches that of a known material or product. A match suggests that the unknown trace object could have a common origin as that of the known material or product.

In other instances, the density of the trace object can be compared to the density of objects of known origin. For example, glitter found on both a victim and an accused perpetrator can be compared. A density match between the two glitter samples suggests that they may have originated from the same source and provides evidence that the victim and an accused perpetrator were in close contact.

In some embodiments, the density of the trace object is compared with densities of one or more objects of known origin, wherein a density match provides an indication of a common origin between the trace object and the objects of known origin.

The common origin may be a manufacturing origin. Thus, a match may suggest the manufacturer of the trace object, or it may even indicate the particular brand made by a specific manufacturer. In other embodiments, it may indicate a subclass of manufacturers or brands to which the trace object may belong.

The common origin may be a geographic location. Thus, a match between the unknown trace object and the object of known density may indicate that they may have both originated from a single geographic location, for example, where the object is composed of a natural product such as wood and wood of that density is known to originate from a limited geographical region.

The common origin may be common ownership or evidence of a single source for both samples. It may indicate a common owner for both the unknown trace object and the known object, for example, where a glitter sample found on the accused perpetrator (unknown) is a density match to glitter samples found on the victim and in the victim's home (known).

A data base can be generated to record densities determined using magnetic levitation (or by other means). Because density is a universal measurement, it can be used and applied everywhere. A forensic laboratory using magnetic levitation could contribute to a generally available database and also access it for an estimate of how common or rare their sample might be. An accurate density determination can aid in determining if a questioned sample is, in fact, different from a known sample.

Choice of Analytes

The objects commonly encountered in crime scenes can be analyzed according to one or more embodiments. Exemplary analytes include smokeless gunpowder, fibers, hair, glitter, shimmer, bone, ivory, glass, wood, dried tree sap, leafy material, feathers, sequins, small jewelry items, buttons, various types of color-effect pigments used in cosmetic products, soil and sand, dried glues, false eyelashes, acrylic fingernails, cremains, cooled hardened metal globules and glass beads produced from industrial processes such as welding or in blast furnaces or electrical power plants, automotive rubber and plastic trim pieces, metal fragments and shavings from industrial sources, dried paint chips, latex condom lubricants, as well as any relatively non-volatile liquids. The ability to analyze certain samples is subject to identification of a suitable paramagnetic solution, e.g., one in which it is inert and that has a density that can be levitated in a magnetic field.

Glitter is a synthetic product, whose composition can range from tiny pieces of aluminum foil to multiple layers of plastic with (or without) an applied metal layer. It may be plastic with a vapor-deposited aluminum layer, or it may consist of multiple layers of plastic with no metal layer at all. Glitter is entirely man-made. In the manufacturing process, before it is cut into individual tiny particles it is in the form of rolled sheets of foil or plastic. Most often the sheets are cut to make particles that are hexagonal, square, or rectangular since these shapes can fully fill a two-dimensional surface with no waste material produced.

Some cosmetics products are advertised as containing “shimmer.” “Shimmer” is not glitter. Shimmer starts off as tiny pieces of mica. Although shimmer particles may fall into a certain size range, their shape is totally irregular and random. In order to increase their sparkle the mica pieces may be coated with titanium dioxide; or iron oxides or other pigments may be added to produce color. Like glitter, shimmer has potential value as associative evidence.

Glitter (or shimmer) is, in many ways, an ideal contact trace: it is nearly invisible; has a high probability of transfer and retention; is highly individualistic; can be quickly collected and separated; small traces are easily characterized; and measured properties of the glitter particles can be placed into a searchable database. Currently, glitter particles in forensic investigations are characterized by a large number of methods: (i) Visual inspection of color, shape, size, and morphology; (ii) The thickness of the glitter particles can be measured mechanically or spectroscopically; and (iii) Attenuated total reflection (ATR) FTIR and Raman microspectroscopy provide insight into the chemical structure of the polymers and coatings used in glitter production. Commercially available glitter particles typically have density values ranging from 1.2-2.5 g/cm³.

Density measurements of glitter particles could provide valuable insight that complements current technologies or can be used in place of current technologies. Density measurements can differentiate glitter particles that are similar in appearance. For example, two glitter pieces can have a similar shape and color as determined by conventional characterization methods, but are distinguished by having different densities. In other examples, two pieces of glitter can be composed of the same polymer base, but differ in density because of the materials applied to them (organic dyes, polymeric materials, and metal particles). Lastly, the heterogeneity of a glitter sample, which can also be determined from magnetic levitation measurements based on the range of observed levitation heights, is yet another indication of the origin of a trace object.

Smokeless powders are encountered in forensic science in the form of residues from gunshots or explosive devices. Smokeless powders are a class of explosive propellant, consisting of gelatinized nitrocellulose with double base powders containing nitroglycerin that produce very little smoke upon deflagration. The decomposition of each of these compounds, results in the release of nitrates, and requires that a stabilizer be added, typically diphenylamine. The ratio of each of these materials, as well as methods of batch preparation, result in density differences in smokeless gunpowder samples/batches. Density determination of smokeless powders can be used to identify the source of the gunpowder, e.g., match the density of the powder found at a crime scene with a known manufacturer or brand, or to determine whether more than one weapon or incendiary had been fired. In other instances, it could be used with additional identifying characteristics (the shape and size of powder particles have marked differences on the burning rate and power generation, with many powders being disk-, cylinder-, or ball-shaped) to assist in the identification of the manufacturer or brand or appropriate subclass.

Many other applications can be envisioned in which the determination of density (or a difference in density) can be instrumental in establishing an association with a crime. In one or more embodiments, the method is used to distinguish between bone and apatite (calcium phosphate minerals having different densities).

In other embodiments, the method could be used to determine the source of an ivory sample among the possible animal sources, in which ivory from different animals species have different densities.

In still other embodiments, the density of a species of wood can be determined and compared with the density of known wood species or a wood sample relative to the investigation.

In still other embodiments, sap collected on the windshield of a car can be matched to the sap of trees in an area of interest to help establish whether the car was in that area.

Magnetic Levitation

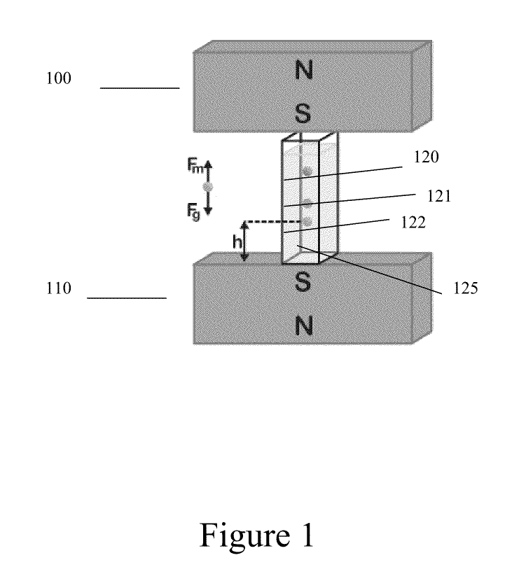

An exemplary magnetic levitation device is illustrated in FIG. 1. The device is small (e.g., 8 cm×6 cm×12 cm) and both portable and inexpensive to fabricate and does not require additional external equipment. A magnetic levitation-based density measurement can be obtained in a short period of time (seconds to minutes, depending on the size of the object). The magnetic field in the magnetic levitation system is established by aligning two magnets 100, 110, e.g., NdFeB permanent magnets, co-axially apart from one another, with like poles facing each other. Diamagnetic objects 120, 121, 122 in a paramagnetic solution 125 are placed within the magnetic field generated by the two magnets. In a magnetic field gradient, suspended in a paramagnetic fluid medium, diamagnetic samples appear to be repelled from regions of high magnetic field; in actuality, the diamagnetic object displaces an equal volume of paramagnetic solution, and it is the attractive interaction between this paramagnetic volume and the regions of high magnetic field and this paramagnetic volume that results in magnetic levitation. The relative position of an object in the vertical direction when placed in the magnetic levitation device, its “levitation height”, is reached when the gravitational (F_{g}) and magnetic forces (Fₘ) acting, in opposite directions, on the object have the same magnitude. Levitation height is indicated as “h” in FIG. 1. This position correlates with the density of the sample. The analytical expression (and the associated assumptions and approximation) for correlating the levitation height of the sample with their density are described in Mirica et al., JACS 2009, 131, 10049, which is incorporated in its entirety by reference. A detailed knowledge of the parameters involved in making this correlation (e.g., the density of the paramagnetic medium, magnetic susceptibility of the medium, the magnetic field at the surface of the magnets) are not necessary in practice of the method.

In the magnetic levitation experiments presented here, each sample is placed in a container, e.g., the 1 cm 1 cm 4.5 cm cuvette shown in FIG. 1. Magnetic levitation density analysis of these samples is achieved by placing them in a solution containing a strongly paramagnetic ion. A variety of aqueous solutions of paramagnetic salts (e.g., MnCl₂, MnSO₄, GdCl₃, FeCl₃, CuSO₄, etc.) and chelated paramagnetic ions (e.g., Gd(DTPA) and Mn(EDTA); both in aqueous and non-aqueous solutions) are suitable for magnetic levitation. In some embodiments, the paramagnetic solution includes MnCl₂ (chosen because the solutions are transparent and because manganese salts are inexpensive).

The density of the paramagnetic solution can vary depending on the solvent (water, organic solvent, oils, etc.) and the dissolved paramagnetic salt. Density ranges of about 0.8 g/cm³ to 3.0 g/cm³ are typical. However, selections of appropriate salts and/or solvents could broaden the range. The salts used to prepare the paramagnetic solutions are mild and not aggressive to most substances. For example, prolonged exposure to a paramagnetic solution, e.g., MnCl₂, does not affect the density of a sample of smokeless gunpowder. Also, repeated measurements (i.e., repeated exposure to a solution of MnCl₂ and washing and drying steps) do not affect the density of a sample of smokeless gunpowder.

Objects of a range of densities can be investigated by selecting a paramagnetic solution having the appropriate density. The concentration of diagmagnetic and paramagnetic ions in solution determines the density of the paramagnetic solution. Densities of common aqueous and organic solutions range between 0.8 and 6.0 g/cm³ so this range is accessible to magnetic levitation.

In some embodiments, the sample can be used in the state in which it was collected. The presence of other impurities in the sample will not affect density determination and the impurities will levitate at different heights.

In some embodiments, the sample is washed before density determination. Impurities that adhere to the surface of the trace object of interest may affect the density measurement, and washing or otherwise cleaning the sample before testing using methods known not to disturb the integrity of the sample may be employed.

In other embodiments, the sample may be embedded in a base, for example, glitter is included in a base in many cosmetic products. The base material can be carefully removed before testing. As indicated below in the examples, such treatment does not affect the density of the glitter.

The presence of tightly adhered particles (e.g., dust, grit, etc.) whose densities are different than the sample of interest can lead to an inaccurate density measurement. Careful preparation methods, in which the sample is cleaned but not altered, are needed to ensure that unwanted materials are removed from the sample. The practice of carefully preparing and analyzing samples of interest is an integral part of forensic science and quantitative analytical chemical methods, and are well known to those of skill in the art.

Sample preparation may results in gas bubbles forming in the holder containing the test sample. While air or gas bubbles that adhere to the wall of the container will not affect the density measurement, the presence of a bubble on or in a sample can greatly influence its overall density (e.g., the density of air is 0.00118 g/cm³ at 25° C. at standard pressure). Thus, it may be advantageous in some embodiments to remove or reduce gas content in the sample. This may be accomplished in a variety of ways, including adding a surfactant to the paramagnetic solution, degassing the solution using a weak vacuum (so that the solvent used in the paramagnetic solution does not evaporate) or sonication. The addition of detergent lowers the surface tension of the aqueous paramagnetic medium, and reduces interactions between hydrophobic objects, as well as their interactions with the walls of the cuvette. Bubbles that form on the walls of the cuvette and on the sample itself can be removed with sonication or by using a sample that has been degassed (e.g., bubbles present on the sample are absorbed into the degassed solution).

The invention is illustrated by the following examples, which are presented for the purpose of illustration only and are not intended to be limiting of the invention.

### Example 1

The density of eleven samples of glitter, each of which was silver in color, was measured by magnetic levitation. Glitter samples were obtained from Meadowbrook Inventions. Table 1 summarizes their properties.

TABLE 1
Thickness and Size of Glitter Samples

| | Thickness | Size | |
|---|---|---|---|
| Glitter Sample^{a} | (μm) | (μm) | Shape |
| ^{b} Alpha Jewels I | 25 | 204 × 204 | square |
| ^{b} Alpha Jewels II | 25 | 635 | hexagonal |
| ^{c} Alpha Jewels Epoxy | 50 | 635 | hexagonal |
| ^{d} Chrome Silver 1P | 178 | 635 | hexagonal |
| ^{e} Crystalina #321 | 28-36 | 635 | hexagonal |
| ^{e} Mirror Crystalina I | 28-36 | 635 | hexagonal |
| ^{e} Mirror Crystalina II | 28-36 | 204 × 204 | square |
| ^{d} Silver 1P Epoxy I | 25 | 102 × 102 | square |
| ^{d} Silver 1P Epoxy II | 178 | 102 × 102 | square |
| ^{d} Silver 1 UP | 13 | 635 | hexagonal |
| Ultrathin Polyester | | | |
| ^{f} Silver Plastic | 178 | 380 × 380 | square |
| Jewels #21 | | | |

^{a} The composition of each glitter particle, as reported from Meadowbrook Inventions, Inc.
^{b} Holographic glitter particles consisting of micro-embossed vacuum metalized (0.5% aluminum) PET.
^{c} Holographic glitter particles consisting of micro-embossed aluminum copolymer particles.
^{d} Metallic glitter particles consisting of vacuum metalized (0.5% aluminum) pigmented PET.
^{e} Iridescent glitter particles with a polyester/acrylic optical core and a polyester outer layer.
^{f} Metallic glitter consisting of a copolymer.

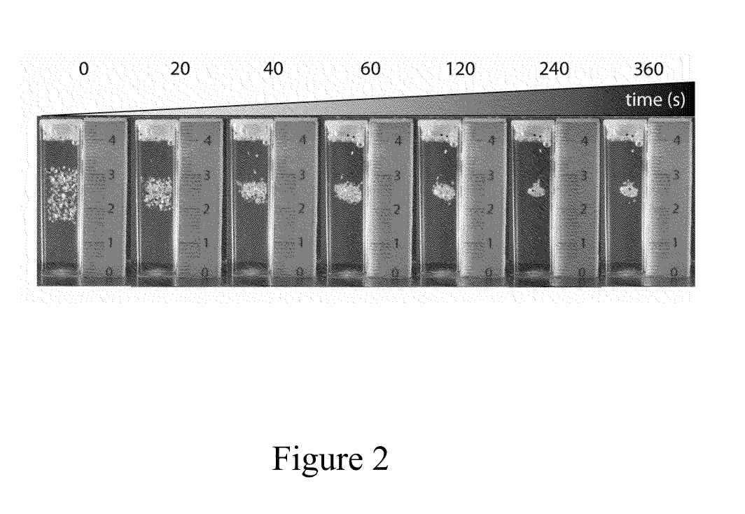

Each sample of glitter was levitated in an aqueous solution of 3.0M MnCl₂. Density standard beads with densities of 1.350 and 1.450 g/cm³ were used to extrapolate the density of each piece of glitter. FIG. 2 contains images of Crystalina #321 (Table 1) at intervals between 0 and 360 seconds after the cuvette of glitter was placed in the Magnetic levitation device. A series of time-lapse photographs were taken to show the time required for a large number of glitter particles to reach the appropriate levitation height of 2.5 cm, determined by their density. These tests demonstrate that equilibrium density is achieved in around three minutes, which was used in all subsequent density determinations unless otherwise noted. A typical density measurement was performed with a smaller number of glitter particles than shown in these photographs; this large number of particles (˜100) is for demonstration and ease of visualization. The objects above 4 cm are air bubbles at the top of the MnCl₂ solution.

The density of each glitter sample was measured using magnetic levitation, with a precision of ±0.001 g/cm³, and compared with the density values provided by the manufacturer. The reported values are from seven independent measurements, with each measurement containing 20 pieces of glitter. The results are reported in Table 2.

TABLE 2
Reported and Measured Densities for Tested Glitter

| | reported density | measured density |
|---|---|---|
| Alpha Jewels I | 2.4 | 1.394 ± 0.002 |
| Alpha Jewels II | 2.4 | 1.392 ± 0.004 |
| Alpha Jewels Epoxy | 1.4 | 1.385 ± 0.001 |
| Chrome Silver 1P | 1.4 | 1.389 ± 0.010 |
| Crystalina #321 | 1.36 | 1.260 ± 0.003 |
| Mirror Crystalina I | 1.36 | 1.258 ± 0.003 |
| Mirror Crystalina II | 1.36 | 1.286 ± 0.041 |
| Silver 1P Epoxy I | 1.4 | 1.383 ± 0.027 |
| Silver 1P Epoxy II | 1.4 | 1.395 ± 0.040 |
| Silver 1UP | 1.4 | 1.394 ± 0.012 |
| Ultrathin Polyester | | |
| Silver Plastic | 5.4 | 1.391 ± 0.014 |
| Jewels #21 | | |

The relative standard deviation for each glitter sample was less than 3.0%. The measured densities for the eleven glitter samples can be broken down into three categories, when compared to the density values reported by the manufacturer: in high agreement with an average density difference of less than 0.05 g/cm³, moderate agreement with an average density difference of greater than 0.05 g/cm³ but less than 0.10 g/cm³, and low agreement with an average density difference of greater than 0.10 g/cm³. Seven samples were in high agreement with the reported density values, two samples were in moderate agreement, and two samples differed by more than 1.0 g/cm³ from the reported density values (Alpha Jewels I and II). It should be noted that each of the density values measured by magnetic levitation are less than those reported by the manufacturer, however when rounded to an equivalent number of significant figures six of the eleven samples match.

### Example 2

This example demonstrates that the removal of nail polish from a glitter sample (using a simple extraction process with acetone and filtration step) does not alter its density. Similar preparation processes can be implemented for other samples.

The density of a glitter sample, of unknown density, from commercial nail polish was determined. The glitter particles were separated from the polish by dissolving 0.5 g of the product in 5 mL of acetone, which was then collected by passing the solution through a piece of Whatman 1 quantitative filter paper. A similar procedure for extracting shimmer particles from make up samples has been reported by Griggs et al., Global Forensic Science Today, 2011, 1, 19. The density of the glitter contained in “New York Color starry silver glitter” (1.274±0.034 g/cm³) and “Sally Hansen diamond strength no chip nail polish” (1.276±0.025 g/cm³) was determined. To ensure that the extraction process employed successfully removed any polish residue from the glitter particles and thus provided an accurate density measurement, glitter particles of known density were introduced into nail polish, and then subsequently removed, cleaned and tested. Approximately 30 pieces of Alpha Jewels I glitter (1.394±0.002 g/cm³) were placed into 0.25 g of Sally Hansen diamond strength nail polish and repeated the extraction and collection process. The levitation heights (i.e., the density) of the Alpha Jewels before and after acetone extraction were compared, and the height of each sample was found to be within the standard deviation of the measurement. This method of extracting glitter from nail polish samples is, thus, an accurate means of obtaining density values from complex cosmetic matrices.

### Example 3

The presence of air bubbles on a sample results in a density measurement that is less than the true density value because air is much less dense than a typical sample. The effect of air bubbles in measuring accuracy was investigated. The density of a glitter sample (Mirror Crystalina I) was measured in cuvettes containing 3.0 M MnCl₂ solutions prepared under a variety of conditions: a MnCl₂ solution, a MnCl₂ solution containing 0.1% (vol/vol) detergent (Tween 20), and a MnCl₂ solution that was degassed. The glitter sample was added to each solution, inverted several times to thoroughly mix the glitter particles, inspected by eye for the presence of bubbles, and a density measurement taken. The average levitation height for each sample preparation was within the standard error of the other measurements (i.e., within 95% confidence, with n=7 measurements of 20 pieces of glitter per measurement). Each cuvette was then sonicated for 20 seconds to remove excess, and difficult to see, bubbles that had collected on the walls of the cuvette or the samples. In the absence of detergent, sonication of the samples resulted in a number of glitter particles adhering to the walls of the cuvette that were very difficult to remove. The spread of levitation heights of glitter within the cuvette was reduced when detergent was present and the sample was sonicated. Adding a small amount of detergent (Tween 20, 0.1% (vol/vol)) and quickly sonicating the solution resulted in the most precise measurement of density for the glitter particles. The average density measurement obtained for each glitter sample was similar, independent of the solution conditions (e.g., the addition of detergent, sonication of the sample). The standard deviations for the glitter samples, however, were larger when detergent was not added and the sample was not sonicated.

### Example 4

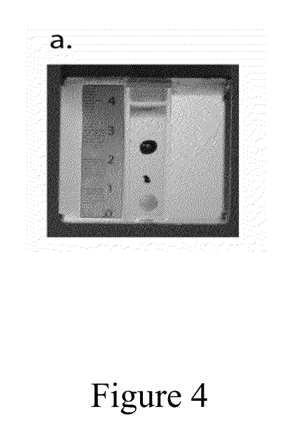

The density of six smokeless gunpowder samples was determined. Each sample was levitated in 4.0 M MnCl₂ (except for Hercules Red Dot, which was levitated in 3.0 M MnCl₂) with 1.4500 and 1.8000 g/cm³ density standard beads. FIG. 4 shows a sample of gunpowder Hercules Blue Dot) levitated in a cuvette containing a 4.0M MnCl₂ solution and two density standards (1.450 and 1.800 g/cm³; dark and light color, respectively), placed in the magnetic levitation device and a photographed after 360 seconds.

The effect of repeated exposure and/or prolonged exposure to an aqueous MnCl₂ solution, which are very acidic in nature with a pH of ˜3.0, on the density of gunpowder samples was investigated. Hercules Blue Dot samples were placed into a solution of 4.0 M MnCl₂ and the density was measured every 24 hours for a total of seven days. The presence of density standards provided a means of accounting for evaporation of water from the solution, and thus changes in the solution density. The change in the average density of the gunpowder after seven days of exposure to aqueous MnCl₂ was 0.012 g/cm³, which is within the standard deviation of the initial measurements.

The density of Hercules Blue Dot gunpowder is also not affected by repeated exposures to MnCl₂ solution. A sample of gunpowder was levitated for ten consecutive measurements, to determine if repeated exposure to MnCl₂ causes changes in the density of the sample. The gunpowder was placed into MnCl₂ solution, levitated in the magnetic levitation device, removed from the MnCl₂ solution, rinsed with water, dried with nitrogen, and the process was repeated. The levitation height variation for each measurement was within the standard deviation is reported in Table 3. The reported values are from seven independent measurements, with each measurement containing three pieces of gunpowder.

TABLE 3
Reported and Measured Densities for Tested Gunpowder

| | height (mm) | density (g/cm³) |
|---|---|---|
| Hercules Red Dot | 27.5 ± 0.28 | 1.226 ± 0.010 |
| IMR Trail Boss | 18.9 ± 0.74 | 1.557 ± 0.059 |
| Hercules Bullseye Orange | 15.3 ± 0.20 | 1.655 ± 0.023 |
| Hercules Blue Dot | 14.8 ± 0.13 | 1.657 ± 0.015 |
| IMR PB | 13.2 ± 0.28 | 1.660 ± 0.030 |
| IMR Hi Skor 800-X | 13.1 ± 0.31 | 1.662 ± 0.025 |

### Example 5

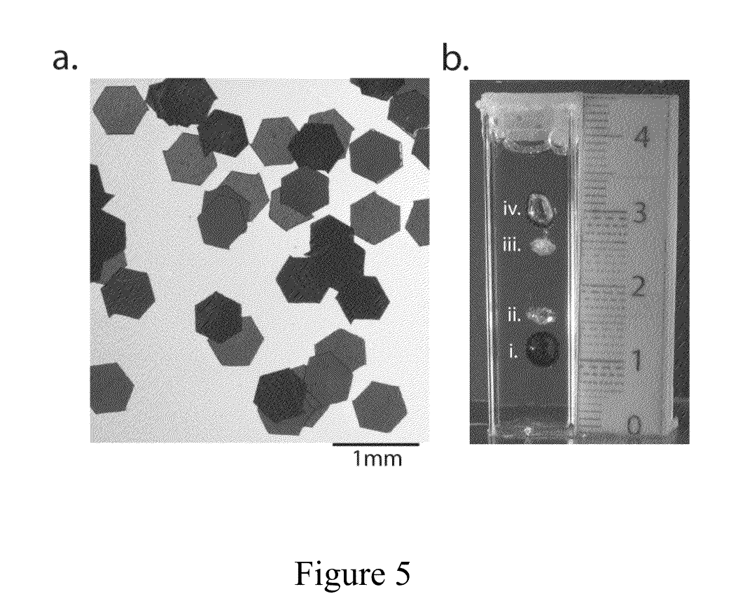

Magnetic levitation can also separate a mixture of objects by their density. A mixture of glitter of similar size and shape (Mirror Crystalina I and Chrome Silver 1P) were separated, which were indistinguishable by eye as they have the same shape and size, however their relative thicknesses are easily determined with a light microscope (FIG. 5A). The two glitter samples are difficult to distinguish without the aid of a microscope, as they are the same size and shape. Their relative darkness in FIG. 5A is representative of their differences in thickness.

A mixture of multiple densities is readily separated in the magnetic levitation device (FIG. 5B). The mixture was placed in a cuvette containing 3.0 M MnCl₂, placed in the magnetic levitation device, and a photograph was taken after 360 seconds. The cuvette contains (i) a 1.450 g/cm³ density standard, (ii) the sample of Chrome Silver 1P glitter, (iii) the sample of Mirror Crystalina I glitter, and (iv) a 1.350 g/cm³ density standard. The mixture of glitter contained ˜50 pieces of each glitter type.

This allows samples that are indistinguishable by eye (or by microscopy) to be separated. An added benefit of separation by magnetic levitation is that samples can be readily sorted: a mixture is placed within the magnetic levitation device, each sample reaches it appropriate levitation height based on density, the sample is removed from the magnet and each discreet sample is collected before the mixture recombines (e.g., glitter is readily removed from the Magnetic levitation solution with a pipette).

It will be appreciated that while a particular sequence of steps has been shown and described for purposes of explanation, the sequence may be varied in certain respects, or the steps may be combined, while still obtaining the desired configuration. Additionally, modifications to the disclosed embodiment and the invention as claimed are possible and within the scope of this disclosed invention.

What is claimed is:

1. A method of classifying the origin of a trace object found at a location or on a person, the method comprising
preparing a suspension of an unknown trace object in a paramagnetic solution, wherein the unknown trace object is obtained from a person or at a location of interest;
applying a magnetic field to the suspension containing the trace object, wherein the position of the trace object in the magnetic field is an indication of its density; and
comparing the density of the trace object with densities of one or more objects of known origin, wherein a density match provides an indication of a common origin between the trace object and the objects of known origin.

2. The method of claim 1, where origin is selected from the group consisting of a manufacturing origin, a geographic location, ownership and combinations thereof.

3. The method of claim 1, wherein the density is determined utilizing a database containing position information correlated with a predetermined density.

4. The method of claim 1, wherein origin of the trace object is determined by comparison to a database containing origin of known objects and density.

5. The method of claim 1, wherein the trace object comprises glitter.

6. The method of claim 1, wherein the trace object comprises gun powder.

7. The method of claim 1, wherein the trace object is selected from the group consisting of hair, fiber, bone, wood, ivory, smokeless gunpowder, fibers, hair, glitter, shimmer, glass, dried tree sap, leafy material, feathers, sequins, small jewelry items, buttons, various types of color-effect pigments used in cosmetic products, soil and sand, dried glues, false eyelashes, acrylic fingernails, cremains, cooled hardened metal globules and glass beads produced from industrial processes such as welding or in blast furnaces or electrical power plants, automotive rubber and plastic trim pieces, metal fragments and shavings from industrial sources, dried paint chips, latex condom lubricants, as well as any relatively non-volatile liquids.

8. The method of claim 1, wherein density is determined at the point of collection.

9. The method of claim 1, wherein the location of collection is a crime scene.

10. The method of claim 1, wherein the trace objects are not washed or rinsed prior to testing.

11. The method of claim 1, wherein the trace objects are cleaned of debris prior to testing.

12. The method of claim 1, wherein the paramagnetic solution comprises a surfactant.

13. The method of claim 1, wherein the suspension is degassed prior to or during application of the magnetic field.

14. The method of claim 1, wherein the suspension is sonicated prior to application of the magnetic field.

15. The method of claim 1, wherein the trace object is glitter and the glitter is separated from a carrier prior to testing.

16. The method of claim 1, further comprising:
receiving information about a second property of the trace object and comparing the information about the second property to properties of objects of known origin, wherein a property match is a further indication of a common origin.

17. The method of claim 16, wherein the trace object is glitter and the second property is selected from the group consisting of color, size, morphology, thickness, shape, and layers.

18. The method of claim 16, wherein the trace object is gun powder and the second powder is selected from the group consisting of color, size, shape and morphology.

19. A system for identifying the origin of a trace object found at a location or on a person, the system comprising:
a pair of permanent magnets positioned to provide a magnetic field of a predetermined field gradient;
a sample holder located within the magnetic field for receiving a sample comprising a trace object; and
a memory for storing a data base containing the origin of known objects correlated with a determined density; and
computer readable medium containing instructions for comparing a measured density against the determined densities of the data base and identifying a match.

20. The system of claim 19, wherein the system is portable.

21. The system of claim 19, wherein the paramagnetic liquid comprises a paramagnetic material dissolved in a solvent.

22. The system of claim 19, wherein the paramagnetic liquid comprises a paramagnetic material dissolved in water.

23. The system of claim 19, wherein the paramagnetic liquid comprises a paramagnetic material dissolved in a non-aqueous solvent.

24. The system of claim 19, wherein the paramagnetic liquid comprises a paramagnetic salt.

25. The system of claim 19, wherein the magnetic field has a linear gradient.

26. The system of claim 25, wherein the magnetic field gradient is linear in a direction along an axis between two magnets generating the magnetic field.
